(19) United States
(12) Patent Application Publication
(10) Pub. No.: US 2009/0210913 A1
(43) Pub. Date: Aug. 20, 2009

(54) METHOD OF CUSTOMER PVR TO NETWORK-BASED DVR SYNCHRONIZATION

(76) Inventors: J. Andrew MacDonald, Ottawa (CA); Jared D. McNeill, Kanata (CA); Martin C. Beckwith, Kanata (CA)

Correspondence Address: WALL & TONG, LLP/;ALCATEL-LUCENT USA INC., 595 SHREWSBURY AVENUE, SHREWSBURY, NJ, 07702, US

(21) Appl. No.: 12/031,438

(22) Filed: Feb. 14, 2008

(51) Int. Cl. H04N 7/18

(52) U.S. Cl. 725/85

(57) ABSTRACT

A method for providing customer PVR to network-based DVR synchronization is described, wherein the said method generally comprises, obtaining cumulative statistics on the number of recordings scheduled for a multi-media broadcast during a period of time; determining the recording schedule for a centralized multi-media recording apparatus based on the said cumulative statistics; and recording at least a subset of the multi-media broadcast with the centralized multi-media recording apparatus, based on the determined recording schedule.

### FIELD OF THE INVENTION

The present invention generally relates to portable multi-media devices and, in particular, to determining content to be provided to portable multi-media devices.

### BACKGROUND OF THE INVENTION

Current Digital Video Recording (DVR) and Personal Video Recording (PVR) methodologies enable customers to record television programming received via a high bandwidth network, such as a fiber optic network, cable television network, satellite network and the like. In this manner, customers may easily record and replay television programming at the location where programming (service) is received, which is typically the customer's residence.

Customers subscribing to television services may also possess portable devices capable of displaying video and/or television programming, such as laptop computers, video-capable cellular telephones and the like. Unfortunately, conventional high bandwidth television networks do not transmit television programming in formats that are recognizable to most portable devices. There has thus far been no available means for conveniently making programming recorded by customers at their home accessible for viewing and/or storage on portable devices in alternate locations.

### SUMMARY

Various deficiencies of the prior art are addressed by the present invention of a method for providing customer PVR to network-based DVR synchronization, the method generally comprising, obtaining cumulative statistics on the number of recordings scheduled for a multi-media broadcast during a period of time; determining the recording schedule for a centralized multi-media recording apparatus based on the said cumulative statistics; and recording at least a subset of the multi-media broadcast with the centralized multi-media recording apparatus, based on the determined recording schedule.

In another embodiment, the invention is directed toward a personal video recorder to network digital recorder synchronization system comprising means for obtaining cumulative statistics on the number of recordings scheduled for a multi-media broadcast during a period of time; means for determining the recording schedule for a centralized multi-media recording apparatus based on the cumulative statistics; and, means for specifying the recording at least a subset of the multi-media broadcast with the centralized multi-media recording apparatus, based on the recording schedule.

In another embodiment, the invention is directed toward a multi-media recording apparatus comprising means of providing data detailing respective recordings scheduled for a multi-media broadcast, to a personal video recorder to digital recorder synchronization system, wherein the personal video recorder to network digital recorder synchronization system comprises means of obtaining cumulative statistics on the number of recordings scheduled for a multi-media broadcast during a period of time; and, means of determining the recording schedule for a centralized multi-media recording apparatus based on the cumulative statistics.

In yet another embodiment, the invention is directed toward a computer readable medium having written upon it a program capable of performing a method comprising obtaining cumulative statistics on the number of recordings scheduled for a multi-media broadcast during a period of time; determining the recording schedule for a centralized multi-media recording apparatus based on the cumulative statistics; and, recording at least a subset of the multi-media broadcast with the centralized multi-media recording apparatus, based on the recording schedule.

### BRIEF DESCRIPTION OF THE DRAWINGS

The teachings of the present invention can be readily understood by considering the following detailed description in conjunction with the accompanying drawings, in which:

FIG. 1 depicts a system suitable for implementing the present invention; and

FIG. 2 depicts a flow diagram of a method for providing customer PVR to network-based DVR synchronization.

To facilitate understanding, identical reference numerals have been used, where possible, to designate identical elements that are common to the FIG's.

### DETAILED DESCRIPTION OF THE INVENTION

The invention will be primarily described within the context of a method for providing customer PVR to network-based DVR synchronization for subscribers to a television broadcast service. However, those skilled in the art and informed by the teachings herein will realize that the invention also applies to any form of multi-media and/or network-type.

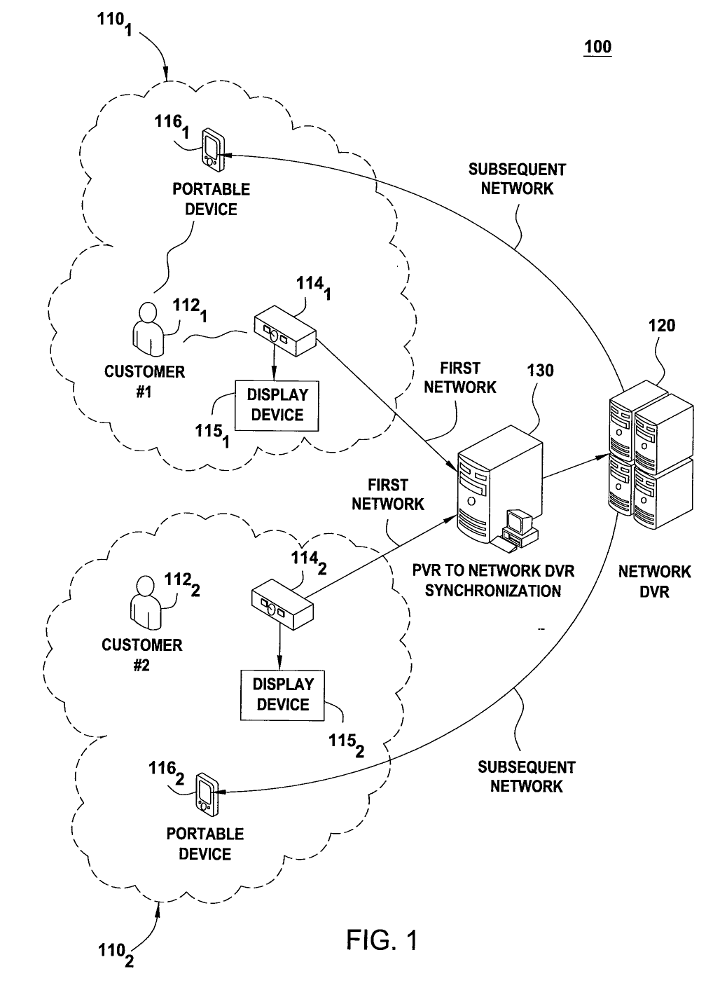

FIG. 1 depicts a system suitable for implementing the present invention. The system 100 of FIG. 1 includes two customer device groups 110, a Network DVR 120, and a PVR to Network DVR Synchronization System 130.

Each customer device group 110 is associated with a respective customer 112 and includes a PVR 114 (such as a home PVR) an optional display device 115 and at least one portable device 116.

Each of the PVRs 114 communicate with the synchronization system 130 via a first network topology. This first network topology may comprise a cable television network, a fiber-optic network or any other relatively high bandwidth access network. As depicted herein, the PVRs 114 optionally-include television signal processing and display circuitry such that the PVRs 114 they operate as set top boxes (STBs). In this configuration, the PVR/STB 114 receives television programming by the first network topology, and records or otherwise processes the television programming to produce a signal suitable for presentation of the television programming on the display device 115. Each PVR 114 may be controlled to record present or future television programming in a conventional manner. In addition, each PVR 114 collects various statistics pertaining to such recordings and propagates the statistics to the synchronization system 130 via the first network.

The synchronization system 130 is configured to obtain various statistics from the PVRs 114, such as the date, time, subject matter and other information associated with scheduled and/or stored recordings. Using these statistics, the synchronization system 130 generates a recording schedule for the network DVR 120. That is, the recording schedule is based upon cumulative or aggregated customer usage statistics. Generally speaking, any usage statistics provided to the synchronizations system 130 via the PVRs 114 may be used to generate the recording schedule for the network DVR 120. It is noted that the synchronization system 130 is depicted as being remotely located from each of the customer device groups 110. However, this synchronization system 130 may also be located proximate a customer device group.

The network DVR 120 uses the recording schedule to record at least a subset of the television programming provided to the customer to device groups 110 via the first networks. The programming recorded on network DVR 120 is then made available to one or more of the portable devices 116 within the customer device groups 110 via the subsequent networks. The network DVR 120 is similar in function to the PVRs 114. The network DVR 120 is preferably scaled up in a manner consistent with multiple recordings for use by multiple portable devices 116.

In various embodiments, the first networks are television provider networks broadcasting a plurality of television programs on multiple channels to residential customers. Examples of such first networks include wired (cable/fiber optic), wireless (satellite), and various high speed Internet Protocol Television (IPTV) networks, wherein the location at which the customer receives the broadcast (the point-of-service) is generally fixed.

In various embodiments, the subsequent networks are telecommunications networks such as mobile telephone networks. Examples of such subsequent networks includes Digital Video Broadcasting-Handheld (DVB-H), Worldwide Interoperability for Microwave Access (WiMax), cellular, IPTV, or regular internet provider networks. Generally speaking, the portable devices 116 are not in communication via the first networks, though such communication is contemplated by the inventors in several embodiments of the invention.

What is described herein as television programming, those skilled in the art and informed by the teachings of the present invention will recognize that any type of multi-media content may be recorded and conveyed in the manner described herein. In general, the multi-media content may be any form of digital or analog media, the recording devices may correspondingly comprise any type of digital or analog recording device, and the first and subsequent networks may be implemented using multiple types of similar or dissimilar network topologies.

TABLE 1
Cumulative Schedule of Recordings for
A Plurality of End-Users on a First Network

| CUSTOMER | CHANNEL | SCHEDULE TIME SEGMENT |
|---|---|---|
| A | 101 | 12:00 PM-2:00 PM |
| A | 101 | 2:30 PM-3:00 PM |
| A | 115 | 5:00 PM-5:30 PM |
| B | 101 | 2:00 PM-2:30 PM |
| B | 101 | 2:30 PM-3:00 PM |
| C | 115 | 6:00 PM-6:30 PM |
| D | 115 | 6:30 PM-7:00 PM |

Table 1 above depicts a cumulative schedule of recordings for a plurality of end-users (customers) on a first network. Specifically, each of four customers (A, B, C and D) has scheduled one or more recordings of television programs on specific channels at specific scheduled time segments. The information in table 1 is accumulated by the synchronization system 130 and used to generate the recording schedule described above with respect to FIG. 1. Other user information is optionally used to generate the recording schedule. It is noted that some of the television programs to be recorded are duplicates in that two or more customers as scheduled the same recording (e.g., channel 101 at 2:30 PM).

TABLE 2
Simplified Recording Schedule

| CHANNEL | SCHEDULE TIME SEGMENT |
|---|---|
| 101 | 12:00 PM-3:00 PM |
| 115 | 5:00 PM-5:30 PM |
| | 6:00 PM-7:00 PM |

Table 2 above depicts a simplified recording schedule generated using the information depicted in table 1. Specifically, the time segments scheduled to be recorded for each channel have been merged into larger time segments associated with each channel. The network DVR 120 is adapted to record each channel for each of the merged/larger time segments with a specific regard to the individual customer channel/time segment schedules. This merging of time segments and, generally speaking, merging or aggregating of individual customer recording requests provides increased efficiency within the context of a network DVR system as the number of customers correspondingly increases. Thus, a recording schedule such depicted above with respect to table 2 is utilized by a central or networked DVR 120 to satisfy the recording requirements of multiple customers. The recorded programming may then be communicated to portable devices 116 via the subsequent networks in response to, illustratively, requests for customer-specific recorded content propagated by a customer's portable device 116 using the customer's corresponding subsequent network.

In one embodiment of the invention, the various processes described above occur at a regular interval to ensure a statistical overview such as that provided in table 2 remains “up-to-date” and the network-based DVR remains synchronized with the programming the customer base has scheduled for recording. Correspondingly, a current repository of recorded programming is optionally made available for delivery to customers/end-users via the subsequent networks in any location, whereas it previously would only have been able to be accessed (viewed) where it was actually recorded.

Thus, the invention allows subscribers to download programming from a centralized recording apparatus and view/execute the programming remotely from any portable device (laptop, video capable cell phone, portable media player, etc.), in whatever its transmission format.

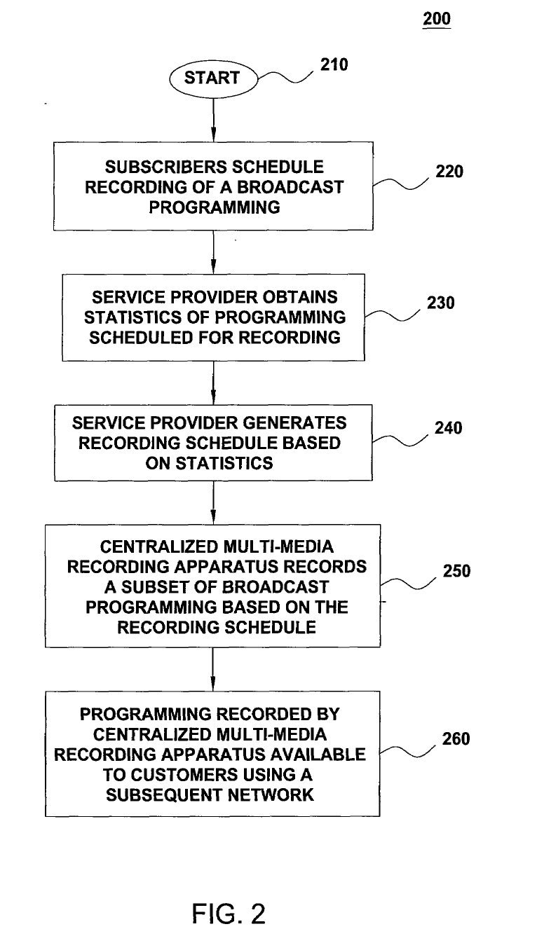

FIG. 2 depicts a flow diagram of a method for providing customer PVR to network-based DVR synchronization. Specifically, the method 200 is entered at step 210 and proceeds to step 220, where customers or subscribers schedule one or more recordings of broadcast programming, such as television programming or other multi-media programming or content. At step 230, the service provider obtains statistics pertaining to the programming scheduled to be recorded. At step 240, the service provider generates a recording schedule using individual, cumulative and/or aggregated customer recording statistics. At step 250, a centralized multi-media recording apparatus such as the network DVR 120 records at least a subset of the broadcast programming according to the generated recording schedule. At step 260, programming recorded by the centralized multi-media recording apparatus is made available to customers using a subsequent network.

In one embodiment, the invention is directed toward a PVR to network DVR synchronization system designed to perform the major functions of the invention, comprising means for obtaining cumulative statistics on the number of recordings scheduled for a multi-media broadcast during a period of time; means for determining the recording schedule for a centralized multi-media recording apparatus based on the cumulative statistics; and, means for specifying the recording at least a subset of the multi-media broadcast with the centralized multi-media recording apparatus, based on the recording schedule.

An embodiment of the invention also comprises a means of communicating with the PVR to network DVR synchronization system. Thus, an embodiment of the invention is also a multi-media recording apparatus, comprising means of providing data detailing respective recordings scheduled for a multi-media broadcast, to a PVR to DVR synchronization system, wherein the PVR to network DVR synchronization system comprises means of obtaining cumulative statistics on the number of recordings scheduled for a multi-media broadcast during a period of time; and, means of determining the recording schedule for a centralized multi-media recording apparatus based on the cumulative statistics.

The above described embodiments of the invention may be implemented within the context of methods, computer readable media and computer program processes. As such, it is contemplated that some of the steps discussed herein as methods, algorithms and/or software processes may be implemented within hardware (e.g., circuitry that cooperates with a processor to perform various steps), software or a combination of hardware and software.

The invention may be implemented as a computer program product wherein computer instructions, when processed by a computer, adapt the operation of the computer such that the methods and/or techniques of the present invention are invoked or otherwise-provided. Instructions for invoking the inventive methods may be stored in fixed or removable media, transmitted via a data stream in a signal bearing medium such as a broadcast medium, and/or stored within a working memory or mass storage device associated with a computing device operating according to the instructions.

Generally speaking, a computing device including a processor, memory and input/output means may be used to process software instructions, store software instructions and/or propagate software instructions to or from a communications channel, storage device or other computer/system.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method, comprising:
determining, for a plurality of subscribers, cumulative statistics of a number of recordings scheduled for programs to be broadcast during a period of time;
defining a recording schedule for a centralized recording apparatus based on the cumulative statistics; and
recording at least a subset of the programs with the centralized recording apparatus according to the recording schedule.

2. The method of claim 1, further comprising, transmitting the multi-media broadcast recorded on the centralized multi-media recording apparatus.

3. The method of claim 2, wherein the cumulative statistics are obtained on a first network, and transmitting the multi-media broadcast recorded on the centralized multi-media recording apparatus occurs on a subsequent network.

4. The method of claim 3, wherein the first network is a television broadcasting network, and the multi-media is television programming.

5. The method of claim 4, wherein the subsequent network is a network that provides multi-media content to portable multi-media devices.

6. The method of claim 5, wherein the centralized media recording apparatus is situated on the first network

7. The method of claim 6, wherein the multi-media is transmitted to one or more of the portable multi-media devices on the subsequent network.

8. The method of claim 7, wherein determining the recording schedule comprises:
obtaining the respective broadcast time periods and channels of multi-media scheduled for recording by end-users on the first network; and
configuring the centralized multi-media recording apparatus to perform a single recording of any multi-media that has been scheduled for recording by one or a plurality of the end-users.

9. The method of claim 3, wherein the same service provider operates the first network and the subsequent network.

10. The method of claim 3, wherein different service providers operate the first network and the subsequent network.

11. The method of claim 3, wherein the subsequent network is a cellular network.

12. The method of claim 3, wherein the subsequent network is a television provider network.

13. The method of claim 3, wherein the subsequent network is an internet service provider network

14. A personal video recorder to network digital recorder synchronization system, comprising:
means for obtaining cumulative statistics on the number of recordings scheduled for a multi-media broadcast during a period of time;
means for determining the recording schedule for a centralized multi-media recording apparatus based on the cumulative statistics; and
means for specifying the recording at least a subset of the multi-media broadcast with the centralized multi-media recording apparatus, based on the recording schedule.

15. The personal video recorder of claim 14, wherein the cumulative statistics are obtained on a first network, and transmitting the multi-media broadcast recorded on the centralized multi-media recording apparatus occurs on a subsequent network.

16. The personal video recorder of claim 15, wherein the first network is a television broadcasting network, and the multi-media is television programming.

17. The personal video recorder of claim 16, where the centralized multi-media recording apparatus is situated on the first network

18. The personal video recorder of claim 17, wherein determining the recording schedule comprises:
obtaining the respective broadcast time periods and channels of multi-media scheduled for recording by end-users on the first network; and
configuring the centralized multi-media recording apparatus to perform a single recording of any multi-media that has been scheduled for recording by one or a plurality of the end-users.

19. The personal video recorder of claim 15, wherein the same service provider operates the first network and the subsequent network.

20. The personal video recorder of claim 15, wherein different service providers operate the first network and the subsequent network.

21. A computer readable medium having written upon it a program capable of performing a method, comprising:
obtaining cumulative statistics on the number of recordings scheduled for a multi-media broadcast during a period of time;
determining the recording schedule for a centralized multi-media recording apparatus based on the cumulative statistics; and
recording at least a subset of the multi-media broadcast with the centralized multi-media recording apparatus based on the recording schedule.

22. The computer readable medium of claim 21, further comprising, transmitting the multi-media broadcast recorded on the centralized multi-media recording apparatus.

23. The computer readable medium of claim 22, wherein the cumulative statistics are obtained on a first network, and transmitting the multi-media broadcast recorded on the centralized multi-media recording apparatus occurs on a subsequent network.

24. A multi-media recording apparatus, comprising:
means of providing data detailing respective recordings scheduled for a multi-media broadcast, to a personal video recorder to digital recorder synchronization system, wherein the personal video recorder to network digital recorder synchronization system comprises:
means of obtaining cumulative statistics on the number of recordings scheduled for a multi-media broadcast during a period of time; and
means of determining the recording schedule for a centralized multi-media recording apparatus based on the cumulative statistics.
